(19) United States
(12) Patent Application Publication
(10) Pub. No.: US 2010/0111144 A1
(43) Pub. Date: May 6, 2010

(54) METHOD FOR DETERMINING AND CHANGING RF CHANNEL AND RF TRANSCEIVING SYSTEM USING THE SAME

(75) Inventor: Chih-Kai CHIU, Tainan City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INDUSTRIAL TECHNOLOGY RESEARCH INSTITUTE, Hsin-Chu (TW)

(21) Appl. No.: 12/388,268

(22) Filed: Feb. 18, 2009

(30) Foreign Application Priority Data
Nov. 6, 2008 (TW) 097142921

(51) Int. Cl. H04B 1/02; H04B 7/00; H04B 1/38

(52) U.S. Cl. 375/219; 455/91; 455/68; 455/73

(57) ABSTRACT

A method for determining and changing RF channels is provided in the present invention, wherein the RF channel is changed randomly and automatically according the communication status so that the communication status between a transmitting end and a receiving end is capable of being maintained to ensure data transmission. In another embodiment, the present invention further provides an RF transceiving system, in which a channel for communication between two wireless transmission modules is constructed automatically and randomly to prevent the communication channel from being duplicated so that channel collision is avoided. In addition, the present invention also provides frequency-hopping to prevent data from being lost and special coding to prevent data from reception error so as to ensure that the data in transceiving process will not be stopping, erroneous, or lost during the user operation.

### CROSS-REFERENCE TO RELATED APPLICATIONS

This non-provisional application claims priority under 35 U.S.C. § 119(a) to Patent Application No. 097142921 filed in Taiwan, R.O.C. on Nov. 6, 2008, the entire contents of which are hereby incorporated by reference.

### BACKGROUND OF THE INVENTION

1. Field of the Invention

The present invention generally relates to a radio frequency (RF) technology and, more particularly, to an RF channel determining and changing method and an RF transceiving system using the method capable of randomly and automatically generating a communication channel according to the communication status.

2. Description of the Prior Art

When there are many persons using wireless transmission devices at the same time in the same room, it is very likely to cause channel collision. With the advancement in technology, there are lots of computers, equipments, cables etc. in the daily life, which results in electromagnetic interference (EMI). Therefore, some channels may be mal-functional to cause interruption of data transmission or reception error when multiple wireless transmission devices are used.

To prevent errors in data transmission and reception due to signal interference, for example, Taiwan Patent Pub. No. I23264 discloses a uni-directional multi-frequency wireless semi-automatic frequency scanning remote device. The device is capable of channel scanning so that the user is able to select a channel at a transmitting end by triggering such mechanism to transmit data and test whether data is received at a receiving end by channel scanning to search the channel required at the transmitting end. If the receiving end fails to receive any data, the user has to re-trigger the channel scanning mechanism. The transmitting end transmits data through a next channel, and the receiving end re-scans the channels.

Moreover, U.S. Pub. No. 20040133921 discloses an RF output channel setting device, using manual setting to change the communication channel. When the user presses a certain button for several seconds according to practical demand, a corresponding channel is acquired at the transmitting end. Meanwhile, the updated channel is available at the receiving end by channel scanning to receive the signal from the transmitting end.

### SUMMARY OF THE INVENTION

The present invention provides an RF channel determining and changing method with frequency-hopping to prevent data from being lost and special coding to prevent data from reception error. If the user wants to re-set the code and the channel, the random value selects the channel and prevents channel collision. When interference takes place to malfunction the channel (at the transmitting end, whether the data has been re-sent for times more than preset is examined; and at the receiving end, whether there is no data received for time longer than preset is examined), frequency-hopping automatically starts. Therefore, in the present invention, when the channel is interfered, frequency-hopping automatically starts to update the channel to ensure that the data in transceiving process will not be stopping, erroneous, or lost during the user operation.

The present invention further provides an RF transceiving system, in which a channel for communication between two wireless transmission modules is constructed automatically and randomly to prevent the communication channel from being duplicated so that channel collision is avoided. The wireless transmission module at the receiving end is further connected to an electronic device so that the wireless transmission module at the transmitting end communicates with the electronic device.

In one embodiment, the present invention provides an RF channel determining method, comprising steps of: generating a random value; determining an updated channel according to the random value; and setting a signal transmitting channel of an RF transmitting device as the updated channel.

### BRIEF DESCRIPTION OF THE DRAWINGS

The objects and spirits of various embodiments of the present invention will be readily understood by the accompanying drawings and detailed descriptions, wherein:

FIG. 1A is a flowchart of an RF channel determining method according to one embodiment of the present invention;

FIG. 1B is a flowchart of steps for generating a random value;

FIG. 1C is a flowchart of steps for determining an updated channel;

FIG. 1D is a remainder-to-channel relation table;

FIG. 2 is a schematic diagram of an RF transceiving system according to one embodiment of the present invention;

FIG. 3A to FIG. 3C are flowcharts of an RF channel changing method of the present invention;

FIG. 4A and FIG. 4B are channel-to-identification-code relation tables of two different RF transmitting devices; and

FIG. 5 is a schematic diagram showing RF wireless data transmission of the present invention.

### DETAILED DESCRIPTION OF THE PREFERRED EMBODIMENT

The present invention can be exemplified but not limited by the embodiments as described hereinafter.

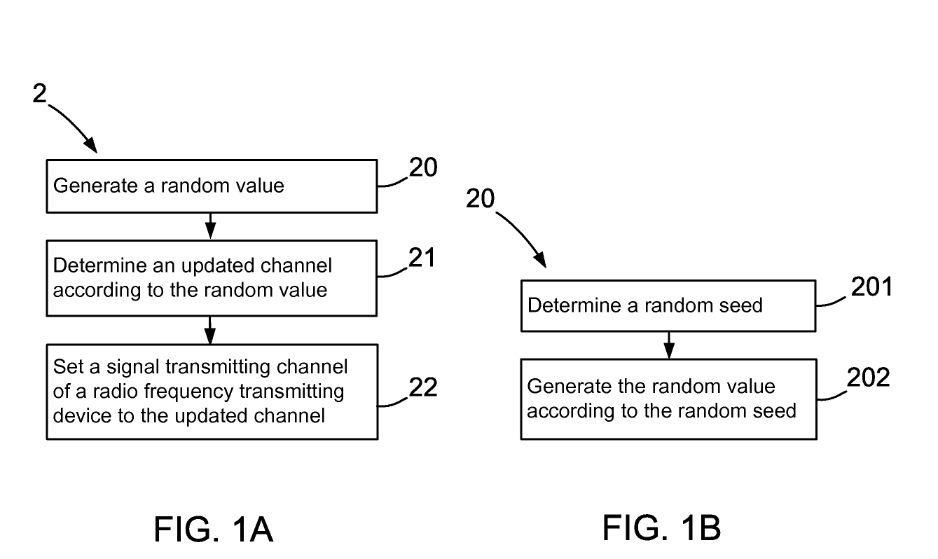

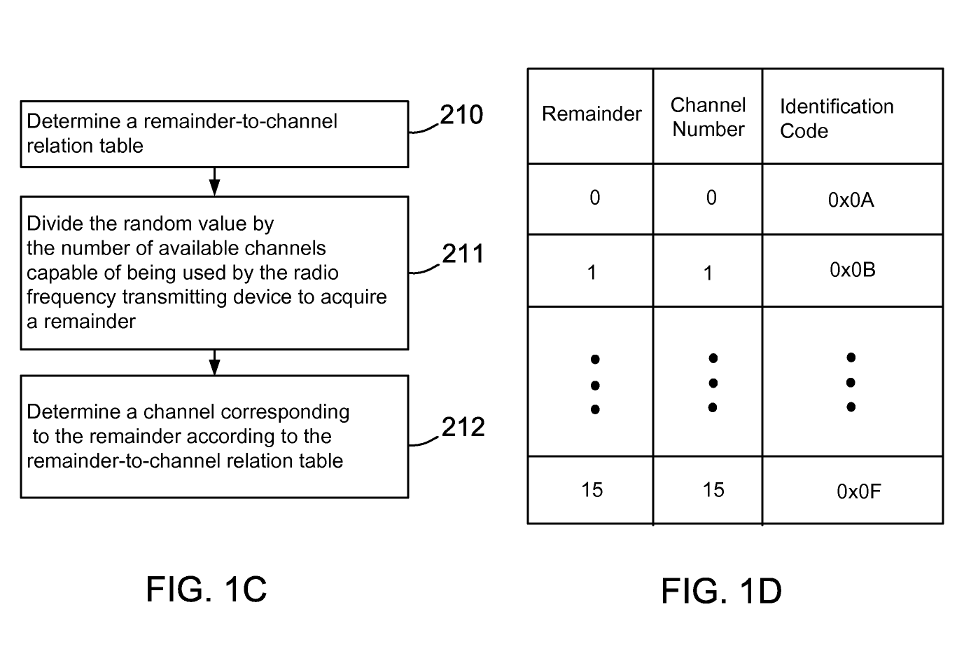

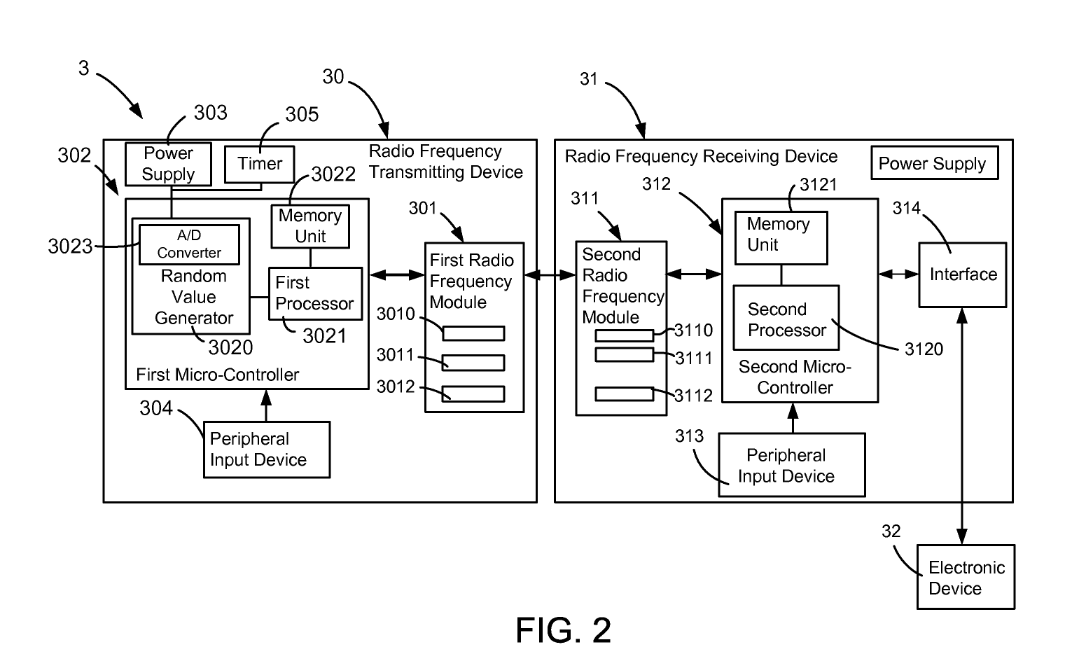

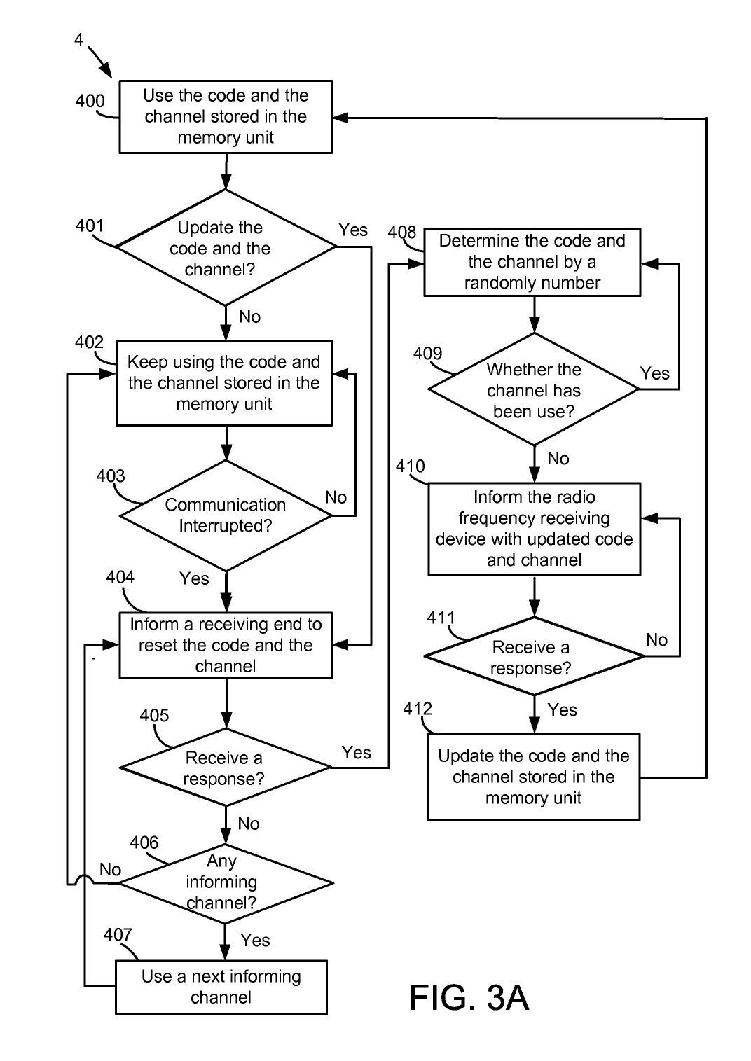

Please refer to FIG. 1A, which is a flowchart of an RF channel determining method according to one embodiment of the present invention. In the present embodiment, the method 2 comprises steps described hereinafter. First, in step 20, a random value is generated. The random value can be generated by various approaches. FIG. 1B is a flowchart of steps for generating a random value according to the present invention. In step 201, a random seed is determined. The random seed can be determined by using a voltage value in a power supply in a transmitting end (an RF transmitting device in the present embodiment) or a time signal generated by a timer. Then in step 202, the random value is generated according to the random seed.

Returning to FIG. 1A, after the random value is generated, an updated channel is determined according to the random value in step 21. Please refer to FIG. 1C, which is a flowchart of steps for determining an updated channel. In step 210, a remainder-to-channel relation table is determined. The remainder-to-channel relation table is shown in FIG. 1D. For example, there are 16 channels, as numbered 0 to 15, available for the RF transmitting device of the present invention. The remainder is determined according to the divisor. Since there are 16 available channels in the present embodiment, the divisor is 16 and the dividend is used as the random value. Moreover, to prevent data from reception error by other devices at the receiving end, the present invention further comprises an identification code corresponding to each channel, as shown in FIG. 1D. As data is sent through a certain channel, the first byte in the transmitted data package is the data code. Therefore, when the data package is decoded, it is determined whether the decoded package is required at the receiving end according to the identification code.

Returning to FIG. 1C, after the table is determined, the random value is divided by the number of available channels capable of being used by the RF transmitting device to acquire a remainder in step 211. Finally, in step 212, a channel is determined corresponding to the remainder according to the remainder-to-channel relation table. For example, the random value generated according to step 20 is 81, which results in a remainder of 1 as 81 is divided by 16. Meanwhile, the corresponding channel number (channel 1 in the present embodiment) and the identification code 0x0B for the channel can be obtained by the remainder of 1 according to the table in FIG. 1D. Returning to FIG. 1A, after the updated channel is determined, step 22 is preformed to set a signal transmitting channel of an RF transmitting device as the updated channel.

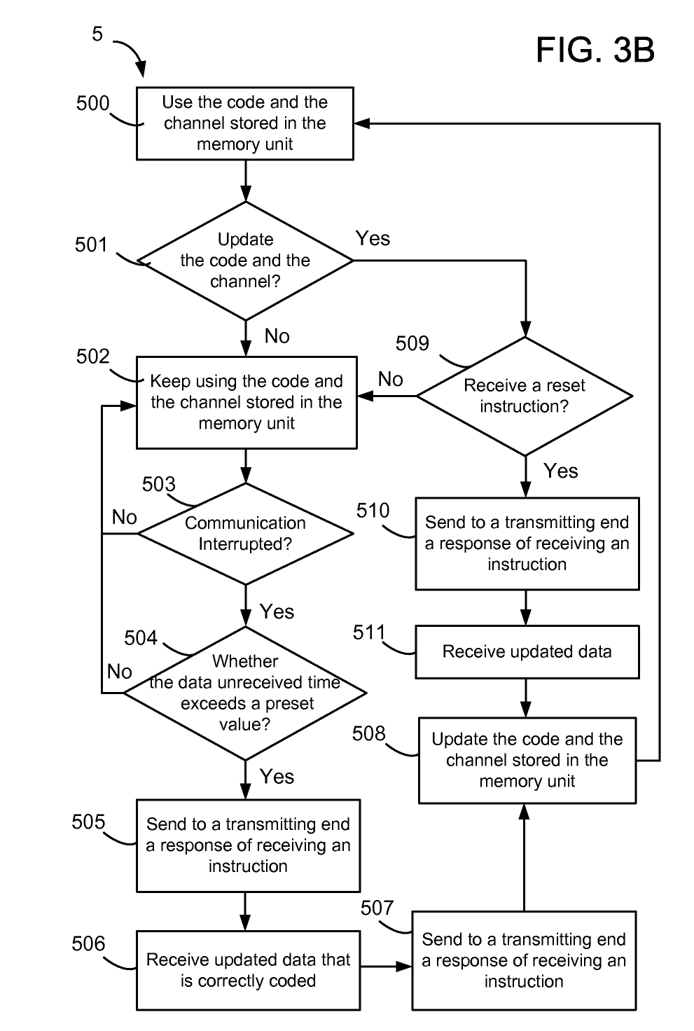

Please refer to FIG. 2, which is a schematic diagram of an RF transceiving system according to one embodiment of the present invention. The RF transceiving system 3 comprises an RF transmitting device 30 and an RF receiving device 31. The RF transmitting device 30 is capable of transmitting RF signals to be received by the RF receiving device 31. Generally, the RF transmitting device 30 is a wireless inertia-sensing mouse, wireless inertia control device or other using RF devices. The RF transmitting device 30 comprises a first RF module 301, a first micro-controller 302, a power supply 303 and a peripheral input device 304. The first RF module 301 comprises a data antenna 3010 and at least one informing antenna(s) 3011, 3012. Even though a plurality of informing antennas are shown in FIG. 2, the number can be one. The number can be determined according to practical demand. The data antenna 3010 corresponds to a communication channel. The data antenna 3010 transmits data signals through the communication channel. The informing antennas 3011 and 3012 correspond respectively to an informing channel. Each informing antenna 3011 and 3012 transmits an informing signal through the informing channel.

The first micro-controller 302 is electrically connected to the first RF module 301. The first micro-controller 302 controls the first RF module 301 to issue signals. In the present embodiment, the first micro-controller 302 comprises a random value generator 3020 capable of generating a random value. The first processor 3021 is electrically connected to the random value generator 3020 and the first RF module 301. The first processor 3021 is capable of automatically changing the channel according to the random value to generate an updated channel to replace the communication channel. In the present embodiment, the random value generator 3020 further comprises an analog-to-digital converter 3023 (ADC), which is electrically connected to the power supply 303. The analog-to-digital converter 3023 is capable of acquiring an analog voltage value of the power supply 303 and converting the analog voltage value to a digital signal as a random seed, from which the random value generator 3020 is capable of generating the random value. Certainly, in another embodiment, the analog-to-digital converter 3023 is also capable of acquiring a signal from the timer 305 and converting the signal to a digital signal as a random seed, from which the random value generator 3020 is capable of generating the random value. The memory unit 3022 is a flash memory or a conventional memory (such as DRAM or SDRAM), but is not limited thereto. The memory unit 3022 is capable of recording the communication channel, informing channel and corresponding identification code (as shown in FIG. 1D) that the first RF module 301 requires when issuing signals. Moreover, the first micro-controller 302 is further coupled to a peripheral input device 304, being a keyboard or a roller.

The RF receiving device 31 comprises a second RF module 311 and a second micro-controller 312. The second RF module 311 comprises a data antenna 3110 and at least an informing antenna(s) 3111 and 3112. Even though a plurality of informing antennas are shown in FIG. 2, the number can be one.

The data antenna 3110 corresponds to a communication channel. The data antennas 3110 and 3112 receive data signal transmitted from the RF transmitting device 30 through the communication channel. The informing antennas 3111 and 3112 correspond respectively to an informing channel. Each informing antenna 3111 and 3112 receives informing signal transmitted from the RF transmitting device 30 through the informing channel. The second micro-controller 312 comprises a second processor 3120 and a memory unit 3121. The second processor 3120 is capable of performing operation on the signal received by the second RF module 311. The memory unit 3121 is a flash memory or a conventional memory (such as DRAM or SDRAM), but is not limited thereto. The memory unit 3022 is capable of recording the communication channel, informing channel and corresponding identification code (as shown in FIG. 1D) that the first RF module 311 requires when receiving signals. The second micro-controller 312 further coupled to is further coupled to a peripheral input device 313, being a keyboard or a roller. The RF receiving device 31 further comprises a interface 314 so as to be electrically connected to an external electronic device 32. The electronic device 32 is a computer, a multi-media gamer or other electronic devices interactive with the user.

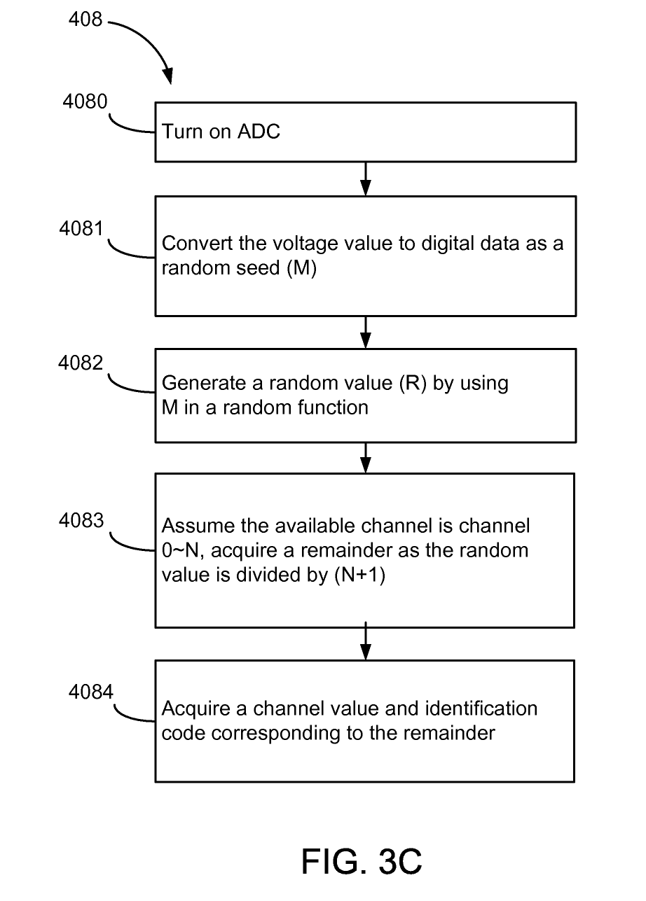

The RF channel changing method of the present invention is described hereinafter. Please refer to FIG. 3A to FIG. 3C, which are flowcharts of an RF channel changing method of the present invention. The flowcharts in FIG. 3A to FIG. 3C are described with reference to the structure in FIG. 2. FIG. 3A is a flowchart showing the operation of the RF transmitting device 30 performed by the first processor 3021, while FIG. 3B is a flowchart showing the operation of the RF receiving device 31 performed by the second processor 3120. In FIG. 3A and FIG. 3B, the method 4 starts with step 400. The data antenna 3010 in the first RF module 301 uses the communication channel stored in the memory unit 3022 to issue signals. In step 500, the second RF module 311 of the RF receiving device 31 uses the code and channel stored in the memory unit 3121 to receive the signals transmitted by the first RF module 301. As the RF transceiving system 3 starts, the RF wireless transmitting and receiving devices 30 and 31 use the code and channel stored in the memory units 3022 and 3121, respectively. Assuming that there is no interference during data transmission, the system 3 keeps using the identification code and channel stored in the memory unit.

After step 400, step 401 is performed to determine whether the communication channel and identification code are to be updated. In step 401, manual approaches are used to update the communication channel and identification code; otherwise, step 402 is performed to keep using the communication channel and identification code stored in the memory unit 3022. Then, step 403 is performed to determine whether communication is interrupted. In step 403, whether communication is interrupted is determined according to whether the second RF module 311 responds with a handshaking signal. Because when the second RF module 311 receives the signal, the first processor 3021 determines that the RF receiving device 31 is out of communication if there is no handshaking signal representing receipt responded. Certainly, determining communication interruption has been disclosed in various approaches and is not limited to the aforementioned examples. If there is no signal interruption, the method returning to step 402. Meanwhile, the steps in the method 5 in FIG. 3B are repeated between step 501 and 502.

Returning to FIG. 3A, if there is signal interruption, step 404 is performed. According to the informing channel and the corresponding identification code used by the informing antenna 3011 stored in the memory unit 3022, the informing antenna 3011 issues the informing signal informing channel changing. Meanwhile, referring to FIG. 3B, in RF receiving device 31, the first RF module 301 transmits the signal informing channel changing according to step 404. Steps 503 and 504 in FIG. 3B are performed to determine that the informing signal transmitted by the informing antenna 3011 of the first RF module 301 is received. In step 505, the corresponding informing antenna 3111 is used to respond with a handshaking signal (ACK) to the RF transmitting device 30.

Returning to FIG. 3A, after step 405 is performed to determine whether the response signal from the second RF module 311 is received, step 408 is performed to update the communication channel. On the contrary, if no response signal is received, it means that the informing channel used by the informing antenna 3011 cannot communicate with the second RF module 311. Therefore, step 406 is performed to determine whether there is any other informing antenna in the first RF module 301, because each informing antenna corresponds to one informing channel. In the present embodiment, since the informing antenna 3011 cannot communicate with the RF receiving device 31, step 407 is performed to update the informing antenna 3012 to inform the RF receiving device 31 to change the communication channel when a second informing antenna 3012 is available. Certainly, if the response is not received from the RF receiving device, step 406 is performed to see if there is any available informing channel. If not, the method returns to step 402.

Returning to step 408, the communication channel is changed. Please refer to FIG. 3C, which is a flowchart of an RF channel changing method of the present invention. First in step 4080, the analog-to-digital converter 3023 (ADC) in the random value generator 3020 is turned on. Referring to FIG. 2, in step 4080, the analog-to-digital converter 3020 acquires the voltage value of the power supply 303 in the RF transmitting device 30. Then, step 4081 is performed to convert the analog voltage value to a digital voltage value to obtain a random seed (M) by using voltage instability. In step 4082, a random value (R) is generated in a random function in the random value generator 3020. Then in step 4083, assuming the available channel is channel 0˜N, a remainder is acquired as the random value is divided by (N+1). In step 4084, a channel value and identification code corresponding to the remainder are acquired according to the table in FIG. 1D, wherein the channel value is an updated channel to be changed.

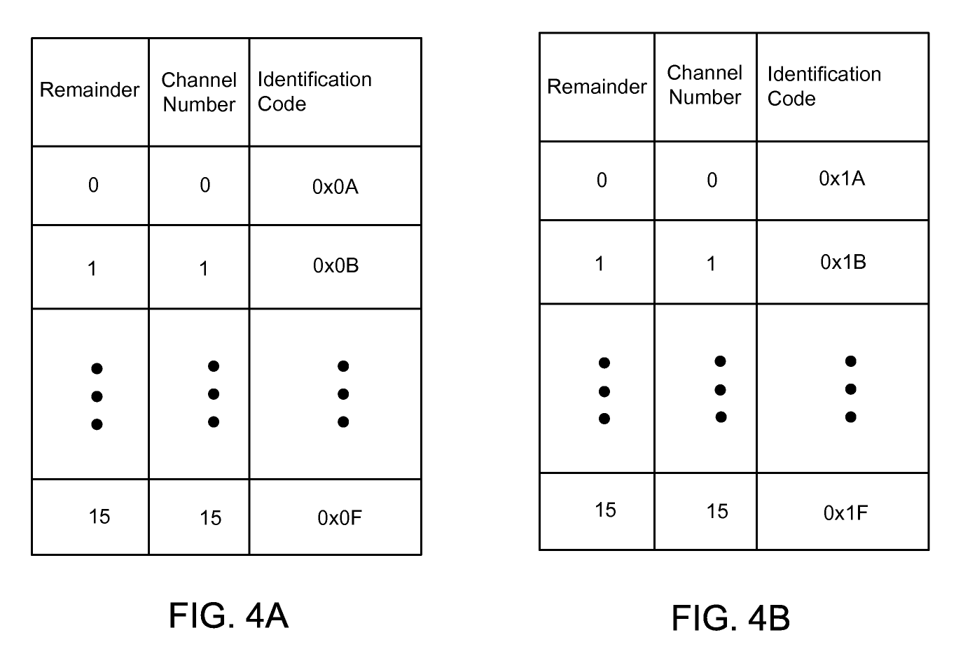

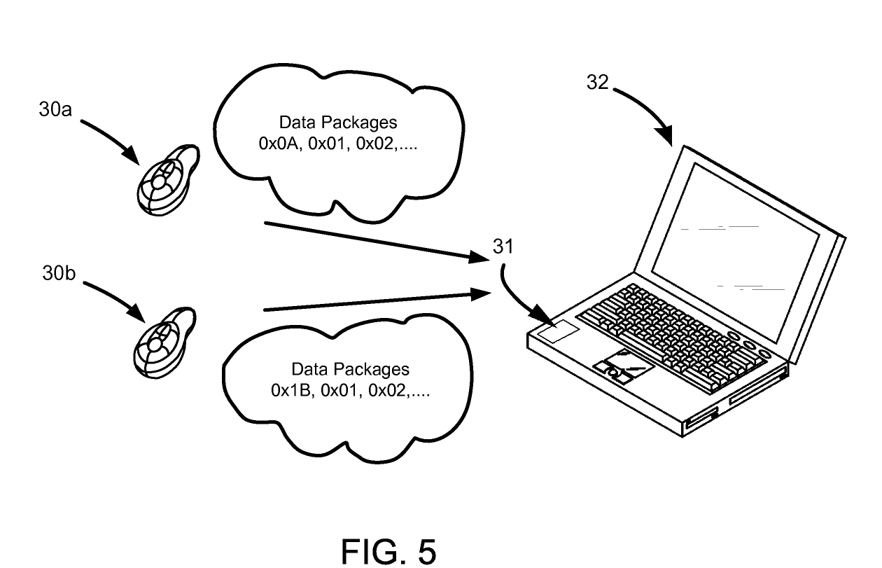

The new identification code is generated to prevent signal interference. To prevent RF receiving device 31 from receiving information from a non-corresponding channel, a specific code is provided on each data package transmitted by the RF transmitting device 30. When the RF receiving device 31 receives the data, the identification code is compared. If the received identification code is not consistent with a pre-determined code, the received identification code is disregarded. If the identification code is correct, it will be stored. Referring to FIG. 4A, FIG. 4B and FIG. 5, wherein FIG. 4A and FIG. 4B are channel-to-identification-code relation tables of two different RF transmitting devices, and FIG. 5 is a schematic diagram showing RF wireless data transmission of the present invention. It is found that the different channels correspond to different identification codes. In FIG. 5, the communication system of the present invention is used in computer control. The two different RF transmitting devices 30a and 30b are wireless inertia-sensing devices capable of communicating with the computer 32 using the RF receiving device 31. Considering that the RF wireless identifying device 30a and the RF wireless identifying device 30b use channel 1 as the communication channel at the same time, since the identification codes are different (0x0B and 0x1B, respectively), data reception error will not happen even if the RF receiving device receives the signal from the RF wireless identifying device 30b when it is requested to receive the signal from the RF transmitting device 30a instead.

Returning to FIG. 3A, after step 408 determines an updated channel and corresponding identification code, step 409 is further performed to check whether the channel is being used to prevent channel collision. In step 409, the RF transmitting device 30 uses the updated channel as a receiving channel. If the first processor 3021 determines that the first RF module 301 has received data through the updated channel, it means that the updated channel is being used. Therefore, the method returns to step 408 to select a new updated channel. On the contrary, if the first processor 3021 determines that the first RF module 301 has not received any data, it means that the channel is free. Meanwhile, in step 410, the informing antenna 3011 transmits an informing signal to inform the RF receiving device 31 with a channel changing signal. Returning to FIG. 3B, after the RF receiving device 31 receives channel changing and identification code signals from the RF transmitting device 30 in step 506, step 507 is performed to respond with a handshaking signal. In step 508, the new channel and corresponding identification code are stored in the memory unit 3121 so that the second RF module 311 can access to the receiving new channel and corresponding identification code.

Returning to FIG. 3A, after a response signal from the RF receiving device 31 is received in step 411, step 412 is performed to store the updated channel and corresponding identification code in the memory unit 3022 to replace the original communication channel and identification code to be used by the RF transmitting device 30. The process stated above is for channel changing when communication interrupted. Moreover, the user can decide to change the channel as well. Referring to FIG. 3A, in step 401, if the user wants to change the channel, step 404 is performed to start channel determining from step 404 to 412 as stated above, which is not repeated herein.

Accordingly, the present invention provides an RF channel determining and changing method and an RF transceiving system using the method with automatic frequency-hopping to prevent data from being lost and special coding to prevent data from reception error so as to ensure that the data in transceiving process will not be stopping, erroneous, or lost during the user operation. Therefore, the present invention is useful, novel and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An RF channel determining method, comprising steps of:
generating a random value;
determining an updated channel according to the random value; and
setting a signal transmitting channel of an RF transmitting device as the updated channel.

2. The RF channel determining method as recited in claim 1, wherein the step of generating the random value further comprises steps of:
determining a random seed; and
generating the random value according to the random seed.

3. The RF channel determining method as recited in claim 2, wherein the random seed is generated according to a characteristic value from the RF transmitting device.

4. The RF channel determining method as recited in claim 3, wherein the characteristic value is a voltage value or a time value.

5. The RF channel determining method as recited in claim 1, wherein the step of determining the updated channel according to the random value further comprises steps of:
determining a remainder-to-channel relation table;
dividing the random value by the number of available channels capable of being used by the RF transmitting device to acquire a remainder; and
determining a channel corresponding to the remainder according to the remainder-to-channel relation table.

6. The RF channel determining method as recited in claim 5, wherein the remainder-to-channel relation table further comprises a channel-to-identification-code relation table.

7. An RF channel changing method, comprising steps of:
using an RF transmitting device to issue a signal in a communication channel to a receiving end;
determining whether the communication channel is to be changed and, if the communication channel is to be changed, informing the receiving end;
determining an updated channel using an RF channel determining method after receiving a channel changing signal from the receiving end; and
using the updated channel to issue a signal to communicate with the receiving end.

8. The RF channel changing method as recited in claim 7, wherein the RF channel determining method further comprises steps of:
generating a random value;
determining an updated channel according to the random value; and
setting a signal transmitting channel of an RF transmitting device as the updated channel.

9. The RF channel changing method as recited in claim 7, wherein the step of generating the random value further comprises steps of:
determining a random seed; and
generating the random value according to the random seed.

10. The RF channel changing method as recited in claim 9, wherein the random seed is generated according to a characteristic value from the RF transmitting device.

11. The RF channel changing method as recited in claim 9, wherein the characteristic value is a voltage value or a time value.

12. The RF channel changing method as recited in claim 7, wherein the step of determining the updated channel according to the random value further comprises steps of:
determining a remainder-to-channel relation table;
dividing the random value by the number of available channels capable of being used by the RF transmitting device to acquire a remainder; and
determining a channel as the updated channel corresponding to the remainder according to the remainder-to-channel relation table.

13. The RF channel changing method as recited in claim 12, wherein the remainder-to-channel relation table further comprises a channel-to-identification-code relation table.

14. The RF channel changing method as recited in claim 7, wherein whether the communication channel is to be changed is determined according to whether a response from the receiving end is received.

15. The RF channel changing method as recited in claim 7, further comprising a step of checking whether the updated channel has been used after the step of determining the updated channel.

16. The RF channel changing method as recited in claim 15, further comprising, after the step of checking whether the updated channel has been used, steps of:
sending an informing signal to the receiving end to inform of the updated channel; and
replacing the communication channel with the updated channel if the response from the receiving end has been received.

17. The RF channel changing method as recited in claim 16, wherein the receiving end updates a receiving channel as the updated channel upon receiving the informing signal.

18. The RF channel changing method as recited in claim 7, further comprising a step of storing the updated channel and an identification code corresponding to the updated channel.

19. The RF channel changing method as recited in claim 7, wherein the step of determining the RF channel determining method further determines an identification code corresponding to the updated channel.

20. An RF transceiving system comprising an RF transmitting device, further comprising:
a first RF module capable of issuing a communication signal according to a communication channel; and
a first micro-controller comprising:
a random value generator capable of generating a random value; and
a first processor being electrically connected to the random value generator and the first RF module, the first processor being capable of performing automatic channel change to generate an updated channel to replace the communication channel according to the random value.

21. The RF transceiving system as recited in claim 20, wherein the first RF module further comprises:
a first data antenna corresponding to the communication channel to provide a data signal; and
at least a first informing antenna corresponding to an informing channel to provide an informing signal.

22. The RF transceiving system as recited in claim 20, wherein the random value generator further comprises an analog-to-digital converter being electrically connected to the random value generator to convert an analog signal to a random seed into the random value generator.

23. The RF transceiving system as recited in claim 22, wherein the analog signal is a voltage signal or a time signal from the RF transmitting device.

24. The RF transceiving system as recited in claim 20, wherein the first micro-controller further comprises a first memory unit for storing the communication channel.

25. The RF transceiving system as recited in claim 20, wherein the first processor divides the random value by the number of available channels capable of being used by the RF transmitting device so as to acquire a remainder, and determines a channel as the updated channel corresponding to the remainder according to a remainder-to-channel relation table.

26. The RF transceiving system as recited in claim 25, wherein the first processor further determines an identification code according to the updated channel.

27. The RF transceiving system as recited in claim 20, further comprising an RF receiving device comprising:
a second RF module capable of receiving the communication signal according to a communication channel; and
a second micro-controller being electrically connected to the second RF module to receive and decode the communication signal to obtain an information data.

28. The RF transceiving system as recited in claim 27, wherein the second micro-controller further comprises a second processor for processing the communication signal and a second memory unit for storing the updated channel.

29. The RF transceiving system as recited in claim 27, further comprising an electronic device electronically connected to the RF receiving device to receive the information data.

30. The RF transceiving system as recited in claim 27, wherein the second RF module further comprises a data antenna and at least one informing antenna.

31. The RF transceiving system as recited in claim 30, wherein the data antenna receives a data signal from the RF transmitting device according to the communication channel.

32. The RF transceiving system as recited in claim 30, wherein the informing antenna is disposed below the informing channel to receive an informing signal from the RF wireless device.

33. The RF transceiving system as recited in claim 27, wherein the second micro-controller is further coupled to a peripheral input device such as a keyboard or a roller.
